(19) United States
(12) Patent Application Publication
(10) Pub. No.: US 2012/0196100 A1
(43) Pub. Date: Aug. 2, 2012

(54) CO-CONTINUOUS POLYMER COMPOSITES WITH ENHANCED MECHANICAL PERFORMANCE AND MULTI-FUNCTIONAL APPLICATIONS

(75) Inventors: Mary C. Boyce, Winchester, MA (US); Lifeng Wang, Cambridge, MA (US); Jacky Lau, Woburn, MA (US)

(73) Assignee: Massachusetts Institute of Technology, Cambridge, MA (US)

(21) Appl. No.: 13/190,725

(22) Filed: Jul. 26, 2011

Related U.S. Application Data
(60) Provisional application No. 61/389,345, filed on Oct. 4, 2010.

(51) Int. Cl. B32B 7/02

(52) U.S. Cl. 428/212

(57) ABSTRACT

Co-continuous structured composite. The composite material includes a continuous material phase in intimate contact with a continuous second phase. A preferred embodiment has a continuous glassy polymer and a continuous elastomeric polymer; or a shape memory polymer phased together with an elastomeric phase. The composite of the invention has a combination of improved mechanical properties such as a unique combination of stiffness, strength and energy absorption, damage tolerance, multiple time constant viscoelastic and viscoplastic behaviors, and shape memory characteristics.

This application claims priority to U.S. provisional application No. 61/389,345 filed Oct. 4, 2010, the contents of which are incorporated herein by reference.

This invention was made with government support under contract number W911NF-07-D-0004, awarded by the Army Research Office. The government has certain rights in this invention.

### BACKGROUND OF THE INVENTION

This invention relates to composite materials and more particularly to co-continuous composites of different materials where each material is three-dimensionally continuous such as two polymers with different mechanical behaviors and time dependence such as a glassy polymer and a rubbery polymer, or a shape memory polymer and a rubbery polymer, or a polymer and a ceramic.

Composite materials can provide improved mechanical performance, for example, by using a combination of light-weight and high stiffness or high strength materials. Therefore, composite materials are widely used in large structures such as aircraft, trains, and cars. Composites are also used in armor to dissipate energy and provide protection during extreme loading conditions (impact, crash, ballistic, blast, shock, projectile, penetration etc.). Various material classes (metals, ceramics, polymers, organic materials) in various structural forms (fibers, platelets, fabrics, foams, particles, etc.) can be used to fabricate composites.

Multifunctional composite materials have been proposed to integrate at least one other function beyond the mechanical property such as the basic strength and stiffness. Composite materials with periodic structural topology can be designed to have integrated thermal, electrical, magnetic, optical, mechanical and possibly other functionalities to provide a unique combination of the individual capabilities, and further have potential impact to structural performance and provide opportunities for composite science and engineering.

Shape memory polymers are smart polymeric materials that have the ability to return from a deformed state to their initial shape induced by an external stimulus such as temperature, change in pH, or light. Shape memory polymers have been developed intensively for use in biomedical devices, microsystems, and deployable space structures owing to their superior structural versatility, low manufacturing cost, and simple processing. In addition to a larger deformation capability, some shape memory polymer applications require high-strength structural components or enhanced toughness.

It is an object of this invention to improve the mechanical properties of polymers by combining them into a composite with one or more other materials with at least two of the materials being three dimensionally continuous.

It is another object of this invention to provide a composite material with enhancements in stiffness, strength and energy dissipation.

It is another object of this invention to provide mechanisms for multi-directional reinforcement.

It is yet another object of this invention to provide mechanisms for dissipating energy to a larger volume of material to enhance energy dissipation prior to catastrophic failure.

It is another object of this invention to provide mechanisms for containing and distributing cracking so as to provide damage tolerance.

It is another object of this invention to provide significant memory of mechanical performance.

It is another object of this invention to provide significant memory of geometric shape.

It is another object of this invention to provide a composite with viscoelastic and viscoplastic behavior over multiple time domains.

It is another object of this invention to provide composite structures that enable a combination of and/or coupling of mechanical deformation with photonic or phononic properties.

It is another object of this invention to provide composite structures that can be scaled down or up and fabricated.

### SUMMARY OF THE INVENTION

The co-continuous microstructured composite material of the invention includes a continuous polymer phase in intimate contact with a continuous second material. In one preferred embodiment, the polymer phase is a shape memory polymer and the second material is an elastomer. The continuous phases of the composites resulting from the invention may intersect on the lattice sites of a simple cubic (SC) lattice, a body-centered-cubic (BCC) lattice, a face-centered-cubic (FCC) lattice, or other lattices.

The composites according to the invention are found to exhibit enhanced mechanical properties achieving a unique combination of multiple properties or behaviors such as stiffness, strength and energy absorption, damage tolerance, multiple temperature and time constant viscoelastic and viscoplastic behavior, and shape memory characteristics.

### BRIEF DESCRIPTION OF THE DRAWING

FIG. 1 is a schematic illustration of the composites disclosed herein.

FIGS. 2a, b, and c are composite materials made according to the invention.

FIGS. 3a and 3b are graphs of nominal strain versus nominal stress for experimental models made according to the invention.

FIG. 4 is a photomicrograph of a composite under compression at a strain of −0.45.

FIGS. 5a and 5b are illustrative graphical representations of the thermo-mechanical loading-unloading-shape recovery cycle and the corresponding stress-strain response of the co-continuous composite achieved by repeating the loading cycle three times.

### DESCRIPTION OF THE PREFERRED EMBODIMENT

Natural and synthetic composite materials consisting of two or more different materials are a major avenue for achieving materials with enhanced properties and combination of properties. Composite microstructures of hard and soft materials provide outstanding combinations of mechanical performance properties including stiffness, strength, impact resistance, toughness and energy dissipation.

The mechanical properties and geometric arrangement of the constituents provide avenues to engineer and tailor the macroscale properties of the composites. Common synthetic microstructures include particles in a continuous matrix, platelets in a continuous matrix, fibers in a continuous matrix, and lamellar structures of alternating layers of different materials. Structures in which both phases are continuous, referred to herein as co-continuous structures, are unusual. However various chemistry processing techniques and technology now enable the production of co-continuous microstructured materials.

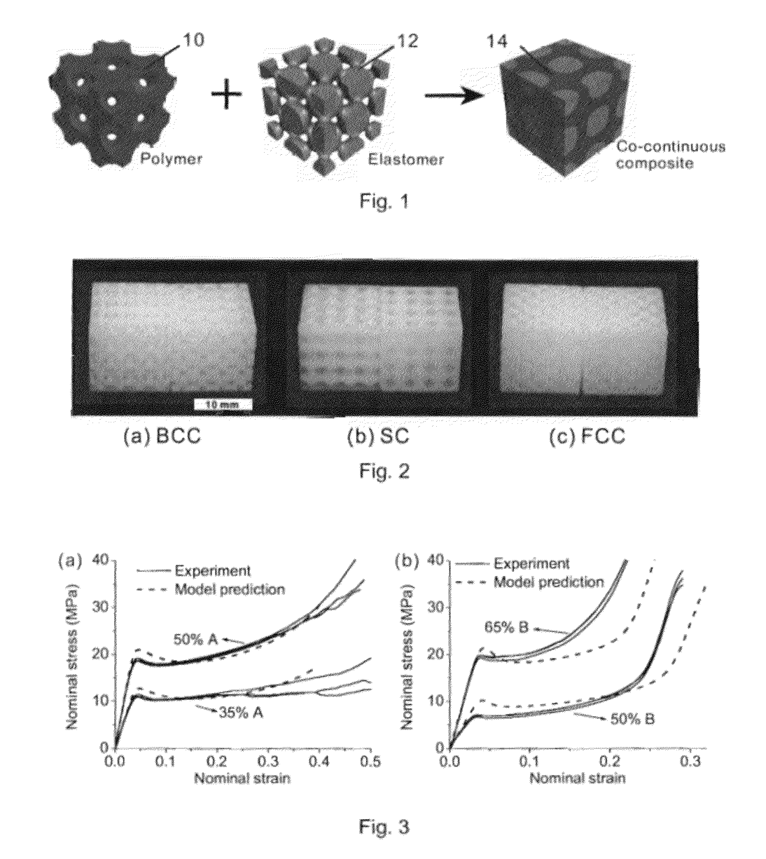

As one example, with reference first to FIG. 1 a polymer 10 (phase A) is combined with an elastomer 12 (phase B) to form a composite material 14 in which both phase A and phase B are continuous in three dimensions. The polymer/elastomer co-continuous composite 14 was fabricated with a Connex500 3D printer (Objet, MA) that allows the simultaneous printing of two different materials. In an experiment, TangoFlus (a rubber-like flexible material) and VeroWhite (an acrylic-based photopolymer) were used in the composites. Input geometries were prepared in Solid Works 2009 and then exported as a stereolithography (STL) file for direct printing in the Connex500. FIGS. 2a, b, and c show examples of composites made using the 3D printer. The composite in FIG. 2a has co-continuous phases which intersect the lattice sites of a body centered cubic lattice while those of the composite in FIG. 2b intersect the lattice sites of a simple cubic lattice. The composite in FIG. 2c intersects face centered cubic lattice sites. The composite height is 14 millimeters and the feature size is ˜500 μm. The volume fraction of each phase in these composites is 50%.

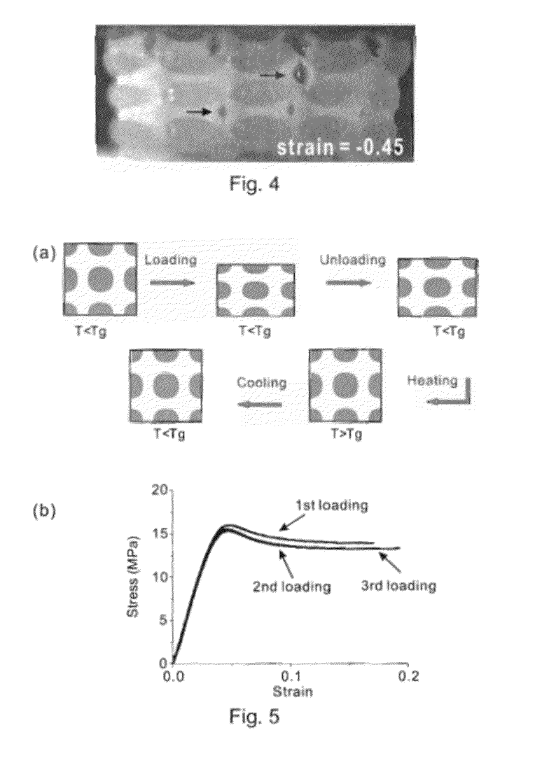

Three samples of the BCC composites shown in FIG. 2a were tested using a Zwick Mechanical Tester; tests were conducted 7 days after fabrication to allow for saturation of curing. The compression tests were conducted at a strain rate of 0.01 s⁻¹. The load was measured from a 10 kN built-in load cell. The nominal stress-nominal strain curves show repeatability up to 40% compression strain as shown in FIGS. 3a and 3b. The stress-strain behavior shows clear initial elastic response, plastic yielding, strain softening and strain hardening at large strain. These curves agree well with the simulation results considering both constituent material (TangoPlus and VeroWhite) properties measured by uniaxial compression tests. The composites with higher contents of glassy polymer provide larger Young's modulus and yield stress as expected by the model. For a composite where phase B is the glassy polymer, the yield stress is increased by a factor of 2.7 when the glassy polymer content changes from 50% to 65%. At much larger strains, cracking is observed to occur at a multitude of locations within the interior of a polymer region (see FIG. 4). However, these cracks do not propagate catastrophically but instead appear at many repeating locations providing enhanced energy dissipation due to the cracking as well as the spreading of plasticity. These cracks also do not reduce the stress level significantly and do not decrease the load carrying ability of the structure, but are evident by the decreasing slope in the experimental stress-strain curves at larger strains in FIG. 3b. The co-continuity of the structure enables these composites to provide energy absorption to larger strains before any complete or catastrophic failure. The cracking mechanism provides additional energy dissipation beyond the mechanism of plasticity spreading to greater volumes of the overall co-continuous material. The mutual support of the two phases provides a load transfer mechanism even in the face of cracking events and gives the damage tolerance of co-continuous composites. These results suggest the tailoring of the microstructure to achieve different failure mechanisms to enhance the energy dissipation under large deformation.

We have found that these composites have interesting shape memory features that enhance the significant recovery of shape and also enhance the significant recovery of mechanical properties (see FIG. 5). Regarding the significant recovery of shape: a shape memory polymer has an internal stress state that evolves with deformation that serves to drive the recovery of the shape upon application of a stimulus such as temperature. In the co-continuous materials of this invention, in addition to the internal stress state within the shape memory polymer phase, additional stress evolves within the second phase (preferably an elastomer or a second polymer phase) which provides a second source of “internal stress” to further drive and hence enhance the recovery upon application of a stimulus. Hence the composite structure geometry, relative volume fractions and materials can be tailored to further tune the time and temperature dependence of the shape memory effect far beyond those of the constituent shape memory polymer phase alone. The recovery effects have been shown experimentally where, for illustrative purposes, the thermo-mechanical loading-unloading-shape recovery cycle (see FIG. 5a) was repeated three times experimentally. Regarding the shape memory effect on the recovery of the mechanical properties: Upon recovery of the shape, the mechanical behavior was measured to determine the degree of degradation in mechanical behavior after large strains that had produced cracks in the microstructure. The stress-strain curves of the second and third time compressions provide almost the same stiffness and strength as compared to the initial compression on the co-continuous composite (as shown in FIG. 5b). The elastomer phase provides large mechanical enhancement and additional recovery force to the composites. Moreover, a composite sample with many cracks still holds 70% of the yield strength and energy dissipation ability after shape is recovered. This provides a fundamental mechanism for a composite that is capable of undergoing multiple loading events.

To investigate the anisotropy of co-continuous composites, FEA simulations were conducted on RVEs subjected to off-axis loadings. The results show that the co-continuous composites are multi-directionally reinforced, are less dependent on material distribution, and simultaneously provide relatively high stiffness, strength and energy absorption in all directions. These properties enable co-continuous composites to be excellent energy dissipative elements in advanced structures or armor by controlling volume fraction and tailoring the geometric arrangement to meet different requirements.

Co-continuous composites also provide the potential of tailored shape memory or viscoelastic and viscoplastic behavior where the two phases can be chosen to tune the shape memory or the viscoelastic behaviors to be activated at multiple temperatures and/or multiple time scales. The periodic and multiphase nature of the structures also enable mechanically tunable band gap (phononic or photonic) materials, and tunable sensors in tissue engineering. While the feature lengthscale of the current study is at the millimeter scale, these results extend down to micron or sub-micron lengthscales where further property enhancement may result due to lengthscale effect on, for example strength and ductility, or alternatively wave propagation.

We have shown experimentally that 3D periodic co-continuous composites can have greater mechanical performance thereby achieving a unique combination of stiffness, strength and energy absorption as compared to conventional particle-reinforced composites, fiber-reinforced composites and lamellar composites. Of particular note, the mutual constraints between two phases of the co-continuous structure enable enhanced dissipation by spreading of the plastic deformation and by containing cracking and giving a multitude of cracking events, leading to a multitude of non-catastrophic dissipative plasticity and cracking events, which also provides damage tolerance of the co-continuous composites.

The invention disclosed herein can be extended to other material combinations such as polymers/ceramic, polymers/metal, and metal/ceramic in co-continuous composites that will potentially provide a much higher stiffness and strength.

Those of skill in the art will appreciate that the present invention applies to all polymers and rubbery polymers. As example, the following polymers are appropriate for use in the invention: thermoplastic polymers in general, polycarbonate (PC), poly(methyl methacrylate) (PMMA), polyurethanes, polypropylene, and SU-8. The following elastomers are also suitable for use in the invention: rubbers and elastomers in general, natural rubber, silicone rubber, polydimethylsiloxane (PDMS), EPDM, polyurethane, and thermoplastic elastomers in general. The second phase can also be non-polymeric such as a carbon, a ceramic, or a metal.

While a 3D printer was used to make the composites shown in FIG. 2, other techniques may be used for making the composite. Examples of other techniques include block copolymer chemistry, rapid prototyping, laser sintering, interference lithography, photolithography, stereo lithography, and self-propagating polymer waveguides.

It is recognized that modifications and variations of the invention disclosed herein will be apparent to those of ordinary skill in the art and it is intended that all such modifications and variations be included within the scope of the appended claims.

What is claimed is:

1. Co-continuous structured composite material comprising a continuous first material phase in intimate contact with a continuous second material phase wherein the first phase and second phase have different mechanical properties.

2. The composite of claim 1 wherein the first phase and second phase are separated by triply periodic surfaces.

3. The composite of claim 1 wherein said first phase is formed of a plurality of materials.

4. The composite of claim 1 wherein said second phase is formed of a plurality of materials.

5. The composite of claim 3 wherein the first phase is a shape memory polymer that enables the significant shape recovery of said composite.

6. The composite of claim 3 wherein the first phase is a shape memory polymer that enables the significant recovery of mechanical property of said composite.

7. The composite of claim 4 wherein the second phase is an elastomer.

8. The composite of claim 7 wherein the second phase is an elastomer that provides additional recovery force to said composite.

9. The composite of claim 2 wherein volume fraction of the two phases is tailored in a wide range.

10. The composite of claim 2 wherein geometry of the two phases is tailored in a wide form.

11. The composite of claim 2 wherein the two phases have different time and temperature transition regimes.

12. The composite of claim 2 wherein the two phases have different viscoelastic and viscoplastic behaviors.

13. The composite of claim 2 wherein the composite phases intersect on a simple cubic (SC) lattice.

14. The composite of claim 2 wherein the composite phases intersect on a body-centered-cubic (BCC) lattice.

15. The composite of claim 2 wherein the composite phases intersect on a face-centered-cubic (FCC) lattice.

16. Co-continuous structured composite materials where more than two phases are continuous and each phase has different mechanical properties
